(19) United States
(12) Patent Application Publication
(10) Pub. No.: US 2020/0251004 A1
(43) Pub. Date: Aug. 6, 2020

(54) Childs Educational Toy

(71) Applicant: Eric Lowe, Jonesboro, GA (US)

(72) Inventor: Eric Lowe, Jonesboro, GA (US)

(21) Appl. No.: 16/710,053

(22) Filed: Dec. 11, 2019

Related U.S. Application Data
(60) Provisional application No. 62/801,203, filed on Feb. 5, 2019.

(51) Int. Cl. G09B 5/06; G09B 19/00; G09B 19/02

(52) U.S. Cl. CPC G09B 5/06; G09B 19/025; G09B 19/0023

(57) ABSTRACT

A childs educational toy including a base structure. The base has a controller and a speaker located therein. The top surface of the base has a plurality of depressions located thereon. The depressions have a corresponding button located therein. Further, the buttons each correspond to a number and a color. When a button is depressed the speaker will play a sound. Each sound is the color and number associated with the button pressed.

### CROSS REFERENCE TO RELATED APPLICATIONS

This application claims the benefit of U.S. Provisional Application No. 62/801,203 filed on Feb. 5, 2019. The above identified patent application is herein incorporated by reference in its entirety to provide continuity of disclosure.

### BACKGROUND OF THE INVENTION

The present invention relates to a childs educational toy. More particularly, the present invention provides a device that will help children learn basic colors and numbers in a fun and interactive way.

There are many ways to attempt to teach a young child basic numbers and color names. The trick is keeping the toddler's attention during the learning process. There are many toys that attempt to do this, however they are not overly successful at keeping the childs attention and teaching at the same time. Another issue is that a toy can keep a childs attention but fail to educate the child.

Other issues are due to the amount that a child can learn from one toy. Children's toys can be extremely costly and some only teach a very limited number of colors or numbers. This means that a parent may have to buy a large number of toys. Further, a child may not progress as quickly as they otherwise would with a limited selection of colors or numbers to learn.

Consequently, there is a need in for an improvement in the art of children's educational toys. The present invention substantially diverges in design elements from the known art while at the same time solves a problem many people face when attempting to teach young children in a fun and interactive manner. In this regard the present invention substantially fulfills these needs.

### SUMMARY OF THE INVENTION

The present invention provides a childs educational toy wherein the same can be utilized for providing convenience for the user when using a toy that is meant to be fun and educational for a young child. The childs educational toy, comprises a base that has a plurality of depressions on a top side thereof. A speaker and a control unit are located within the base. Each depression has at least one button located therein, wherein the buttons are connected to the control unit. The area surrounding each button is further colored to help children learn colors.

Another object of the childs educational toy is that the speaker will play a sound when a button is pressed.

Another object of the childs educational toy is that the sound corresponds to the button pressed. For example, if the button with a one on it is pressed the speaker will play the word “one”.

Another object of the childs educational toy is that each button is given a unique color.

Another object of the childs educational toy is that the toy further includes a plurality of lights that correspond to the button. The lights may be within the button or surrounding the button.

Another object of the childs educational toy is that each depression has a corresponding number.

Another object of the childs educational toy is that each number corresponds to a button.

Another object of the childs educational toy is that the depressions represent human hands. This will allow a child to place his or her hands within the depressions.

Another object of the childs educational toy is that each depression has at least one button located in the finger portions.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the childs educational toy.

FIG. 2 shows a perspective view of an embodiment of the childs educational toy wherein the depressions are hand shaped.

FIG. 3 shows a top down view of an embodiment of the childs educational toy where there are additional buttons.

FIG. 4 shows a perspective view of an embodiment of the childs educational toy where the hands are indented.

FIG. 5 shows a diagram of an embodiment of the wiring of the childs educational toy.

### DETAILED DESCRIPTION OF THE INVENTION

Reference is made herein to the attached drawings. Like reference numerals are used throughout the drawings to depict like or similar elements of the childs educational toy. For the purposes of presenting a brief and clear description of the present invention, a preferred embodiment will be discussed as used for the childs educational toy. The figures are intended for representative purposes only and should not be considered to be limiting in any respect.

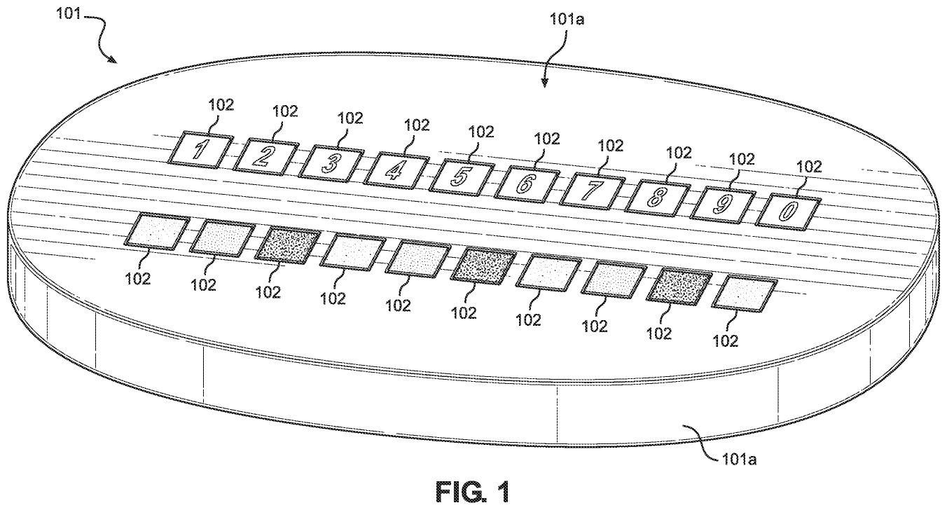

Referring now to FIG. 1, there is shown a perspective view of an embodiment of the childs educational toy. The childs educational toy is comprised of a base 101 and a plurality of buttons 102. The base has a top side 101a and at least one sidewall 101b. The base 101 has an interior volume. In one embodiment, the base 101 is an oval. This will provide an elongated base 101 that will allow for enough buttons 102 to be placed thereon. Additionally, there will not be any corners so as to prevent injuries to the child during use. The lack of corners will provide for a safer toy. While the drawings show an embodiment of an oval, other shapes are also contemplated.

The plurality of buttons 102 are placed in various places along the topside 101a of the base 101. In one embodiment, the plurality of buttons 102 are square buttons. In another embodiment, the plurality of buttons 102 are circular buttons. In yet another embodiment, the buttons 102 are a mixture of shapes. The plurality of buttons 102 may represent different things. In one embodiment, the plurality of buttons 102 represent numbers. In another embodiment, the plurality of buttons 102 represent colors.

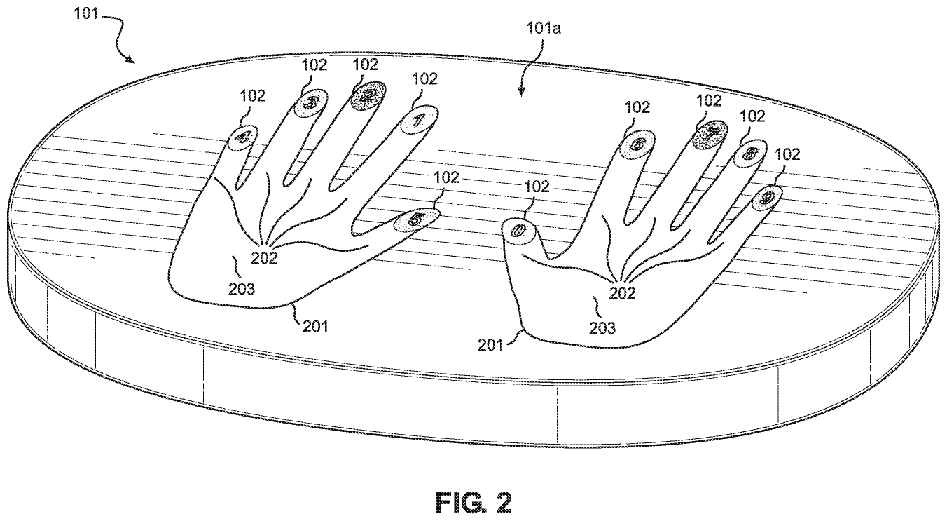

Referring now to FIG. 2, there is shown a perspective view of an embodiment of the childs educational toy wherein the depressions are hand shaped. In some embodiments, the childs educational toy is further comprised of at least one hand shape 201 located on the top side 101a of the base 101. The hand shapes 201 will have a palm portion 203 and a plurality of finger portions 202. The finger portions 202 will have resemble human hands, having finger times and connections to the palm portion 203.

The hand shapes 201 will help guide a child as to where to place their hand on the toy. In one embodiment, there are two mirrored hand shapes 201 to represent a right hand and a left hand. This will allow the child to place both hands on the toy. In an embodiment where there are hand shapes 201, the plurality of buttons 102 are located in the fingertips of the finger portions 202. With the plurality of buttons 102 located in the fingertips the child can naturally press the plurality of buttons 102. In an embodiment where the plurality of buttons 102 are located in the fingertips, they may each represent a color and a number.

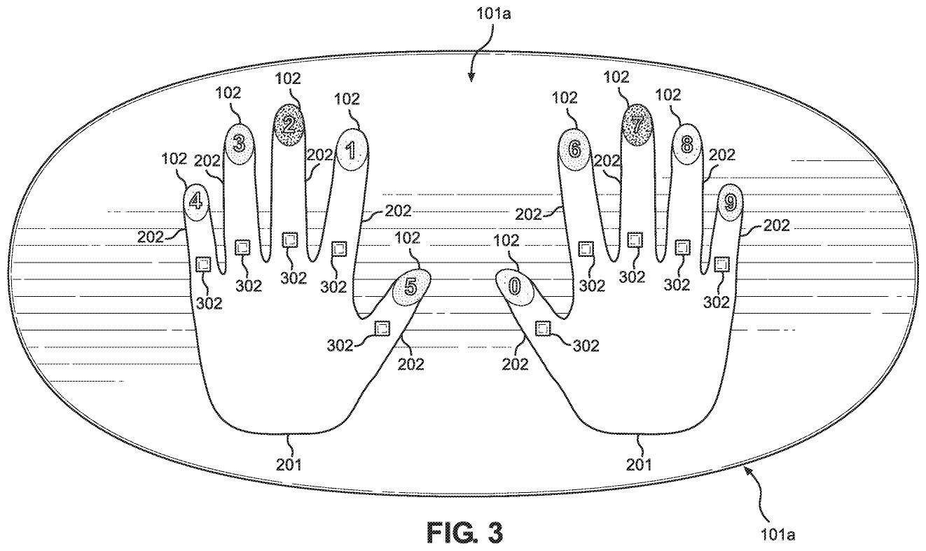

Referring now to FIG. 3, there is shown a top down view of an embodiment of the childs educational toy where there are additional buttons. In another embodiment, the childs educational toy has additional buttons 301 located on the top side 101a of the base 101. In these embodiments, some of the plurality of buttons 102 are located in the fingertips of the finger portions 202. In one embodiment, the plurality of buttons 102 located in the fingertips represent numbers. In one embodiment, there are further buttons 302 located at the base of the finger portion 202 of the hand shapes 201. In an embodiment, these buttons 202 represent colors. In the embodiments where the buttons 202 represent colors, each button may represent a different color.

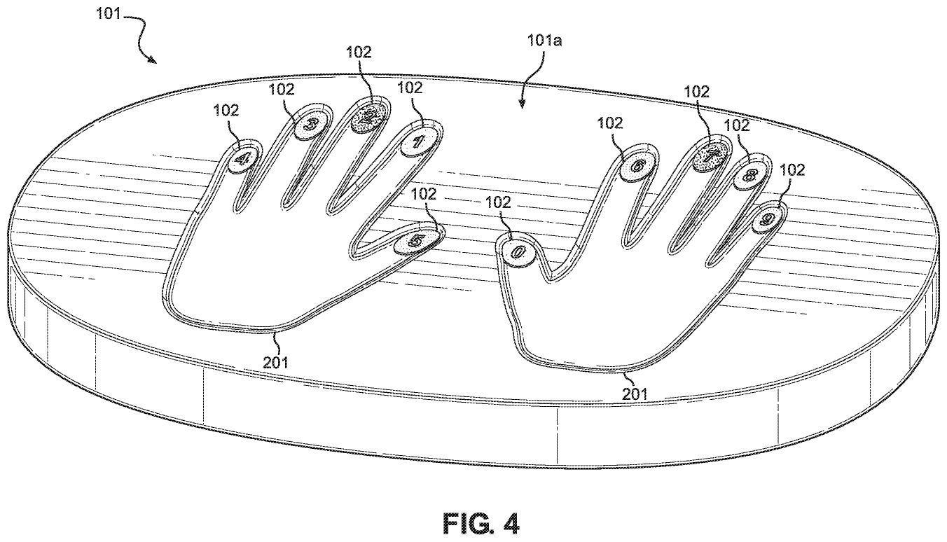

Referring now to FIG. 4, there is shown a perspective view of an embodiment of the childs educational toy where the hands are indented. In another embodiment of the childs educational toy, the hand shapes 201 are indented into the top side 101a of the base 101. In one embodiment, the hand shapes 201 are indented such that a childs hand will fit within the indents. In another embodiment, the hand shapes 201 are indented to a depth that will allow a childs hand to fit at least halfway within the indents. In yet another embodiment, the hand shapes 201 are indented to a depth that the childs hand will be able to rest on top of the indents but enough that there is a feeling of different levels between the top side 101a and the indents.

In FIG. 4, it is further shown that the plurality of buttons 102 are raised. It is contemplated that the plurality of buttons 102 can be raised in any of the embodiments of the present application. The raised buttons 102 can help a child locate the buttons 102 and press them. Further, the raised buttons 102 will ensure that the buttons 102 are easily pressed. While non-raised buttons 102 are also contemplated and will fulfill the intentions of the present application, there is a drawback to using such buttons. The button 102 will have to be depressed into the top side 101a of the base 101 which could allow a childs finger to become pinched between the buttons 102 and the base 101.

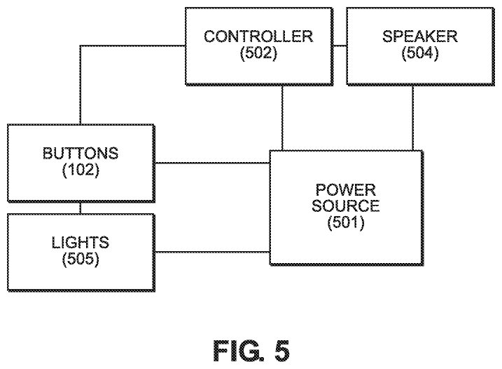

Referring now to FIG. 5, there is shown a diagram of an embodiment of the wiring of the childs educational toy. The childs educational toy has several elements that are located within the base of the device in addition to the plurality of buttons 102. There is a power source 501 located within the base of the childs educational toy. In one embodiment, the power source 501 is an outlet plug and the outlet provides the power. In another embodiment, the power source 501 is a battery. In one of the embodiments where the power source 501 is a battery, the battery is rechargeable. The power source 501 is operably coupled to a speaker 504, the plurality of buttons 102, a controller 502, and a plurality of lights 505.

The controller 502 is operably coupled to the plurality of buttons 102 and the speaker 504. In one embodiment, when the buttons 102 are pressed the controller 502 will signal the speaker 504 to play the corresponding number or color. In another embodiment, the controller 502 will signal the speaker 504 to recite a color or a number. In this embodiment, the controller 502 will register if the correct button is then pressed to correspond to the recited color or number and signal the speaker 504 to recite correct or incorrect respectively.

In some embodiments there are lights 505 operably coupled to the buttons 102. The lights 505 are configured to illuminate when the buttons 102, 302 are pressed. In one embodiment, the buttons 102, 302 are transparent and the lights 505 are integrated within the buttons 102. In another embodiment the lights 505 are placed in the top side of the base. In this embodiment there is a transparent section that surrounds each button. The lights 505 will shine through the transparent section and display a color.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A childs educational toy, comprising:
a base having a plurality of depressions on a top side thereof;
a speaker is disposed of within the base;
a control unit is disposed of within the base;
the speaker, the speaker is operably coupled to a control unit;
wherein the speaker is configured to play a sound;
each depression has at least one button located therein, wherein the buttons are operably coupled to the control unit;
wherein, each button has a unique indicia thereon.

2) The childs educational toy of claim 1, wherein the speaker will play a sound when a button is pressed.

3) The childs educational toy of claim 2, wherein the sound corresponds to the indicia on the button pressed.

4) The childs educational toy of claim 1, wherein each indicia is further given a unique color.

5) The childs educational toy of claim 1, further comprising a plurality of lights that correspond to the buttons.

6) The childs educational toy of claim 1, wherein each depression has a corresponding number.

7) The childs educational toy of claim 6 wherein each number corresponds to a button.

8) A childs educational toy, comprising:
a base having a plurality of depressions on a top side thereof;
the depressions represent human hands, wherein the hands each have a palm portion and finger portions extending from the palm portion;
each depression has at least one button located in the finger portions;
within the base there is located a speaker, and a control unit;
the buttons are operably coupled to the control unit;
the finger portion surrounding each button is colored.

9) The childs educational toy of claim 8, wherein the speaker will play a sound when a button is pressed.

10) The childs educational toy of claim 9, wherein the sound corresponds to the button pressed.

11) The childs educational toy of claim 8, wherein each button is given a unique color.

12) The childs educational toy of claim 8, further comprising a plurality of lights that correspond to the buttons.

13) The childs educational toy of claim 8, wherein each finger of the hand depression has a corresponding number.

14) The childs educational toy of claim 13, wherein each number corresponds to a button.

15) The childs educational toy of claim 10, wherein the sound is the color corresponding to the button.

16) The childs educational toy of claim 13, wherein the sound is the number corresponding to the button
